(19) United States
(12) Patent Application Publication
(10) Pub. No.: US 2026/0032064 A1
(43) Pub. Date: Jan. 29, 2026

(54) OPTIMIZED PROFILE MANAGEMENT APPLICATION PROCESSING FOR DOWNSTREAM CHANNELS IN A SERVICE PROVIDER NETWORK

(71) Applicant: Charter Communications Operating, LLC, St. Louis, MO (US)

(72) Inventor: Joel Michael Foust, Aurora, CO (US)

(73) Assignee: Charter Communications Operating, LLC, St. Louis, MO (US)

(21) Appl. No.: 18/785,895

(22) Filed: Jul. 26, 2024

(51) Int. Cl. H04L 43/026; H04L 12/28; H04L 41/147

(52) U.S. Cl. CPC H04L 43/026; H04L 12/2801; H04L 41/147

(57) ABSTRACT

Methods and systems for optimizing profile management application processing for downstream channels in a service provider network are described. A method for automated optimization of profile management application (PMA) processing for downstream channels in a service provider network, the method includes obtaining, by a collector in a service provider system from cable modems in a service provider network, data for downstream channels having expired collection timestamps, setting, by an analytics engine, the collection timestamps for each of the downstream channels, and dynamically determining, by the analytics engine, PMA profile application times for each of the downstream channels based on at least the data.

### TECHNICAL FIELD

This disclosure relates to telecommunications systems. More specifically, this disclosure relates to management of broadband communications networks and services.

### BACKGROUND

Data Over Cable Service Interface Specification (DOCSIS) is a cable communication standard which enables the providing of high-bandwidth data transfers, such as Internet access. over existing infrastructure such as cable television (CATV) systems. DOCSIS 3.1 and later specifications provide increased performance for hybrid fiber coaxial (HFC) systems by using Orthogonal Frequency Division Multiplexing (OFDM) in the downstream. OFDM enables stacking of a large number of small subcarriers spaced 25 KHz or 50 KHz apart into a wider bandwidth channel up to 192 MHz wide. Each subcarrier within the OFDM channel can be configured to operate at different modulation orders because signal quality conditions can vary greatly over the channel. Modulation orders are configured in a limited number of segments which have start and stop frequencies aligned with subcarrier band edges. For example, for a 192 MHz channel there are ˜3840 subcarriers. Profile Management Application (PMA) allows configuration of groups of subcarriers up to a limited number of segments. These are known as profiles.

Noise conditions experienced by cable modems vary with time and from cable modem to cable modem. PMA is used to measure and collect telemetry data from cable modems to determine an optimal set of profiles (i.e., PMA profiles) for a given OFDM channel. Given the large number of OFDM channels present in a service provider network as well as the time varying nature of signal quality, automation is leveraged to equate and apply PMA profiles. Equating optimized profiles and application of downstream DOCSIS OFDM profiles using PMA is traditionally done at fixed intervals.

The rate and severity of change to signal quality for a given OFDM channel is not consistent across the large number of OFDM channels in a service provider network. It is costly and resource intensive to apply PMA across the entire service provider network at short, fixed time intervals. Therefore, in a fixed interval PMA system, the overall network efficiency, customer experience, and resource utilization are not optimized.

### SUMMARY

Disclosed herein is a system and method for optimizing profile management application processing for downstream channels in a service provider network. In implementations, a method for automated optimization of profile management application (PMA) processing for downstream channels in a service provider network, the method includes obtaining, by a collector in a service provider system from cable modems in a service provider network, data for downstream channels having expired collection timestamps, setting, by an analytics engine, the collection timestamps for each of the downstream channels, and dynamically determining, by the analytics engine, PMA profile application times for each of the downstream channels based on at least the data.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a system architecture in accordance with embodiments of this disclosure.

FIG. 2 is a diagram of an example of profile management application (PMA) processing on a fixed interval.

FIG. 3 is a diagram of an example of dynamic PMA processing in accordance with embodiments of this disclosure.

FIG. 4 is a diagram of an example of dynamic PMA processing using PMA profile feedback in accordance with embodiments of this disclosure.

FIG. 5 is a diagram of an example of dynamic PMA processing using historical data in accordance with embodiments of this disclosure.

FIG. 6 is a diagram of an example of dynamic PMA processing using telemetry data comparisons in accordance with embodiments of this disclosure.

FIG. 7 is a flowchart of an example method for dynamic PMA processing in accordance with embodiments of this disclosure.

FIG. 8 is a block diagram of an example of a device in accordance with embodiments of this disclosure.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU) s, one or more graphics processing units (GPU) s, one or more digital signal processors (DSP) s, one or more application specific integrated circuits (ASIC) s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements. Further, the figures and descriptions provided herein may be simplified to illustrate aspects of the described embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a system and method for optimizing profile management application (PMA) processing for downstream channels in a service provider system. In implementations, the system and methods described herein can optimize a timeframe for collection, computation, and application of PMA profiles using PMA on a per Orthogonal Frequency Division Multiplexing (OFDM) channel basis to improve network efficiency, improve customer experience, and reduce resource utilization. In implementations, the system and methods can predict optimal times to perform at least one of collect telemetry from cable modems, equate new PMA profiles, apply PMA equated profiles, and/or combinations thereof.

In implementations, methods are provided which can select the optimal times to complete one or more parts of the PMA process or cycle. In implementations, the methods can include a feedback approach which can analyze cable modem adherence to predicted profiles on a per OFDM channel or service group basis. In implementations, the methods can include use of historical data to predict optimal times based on anticipated signal variance. In implementations, the methods can include comparison of last collected telemetry data to telemetry data used to equate current PMA profile to determine if variance exceeds a threshold required to trigger the PMA process.

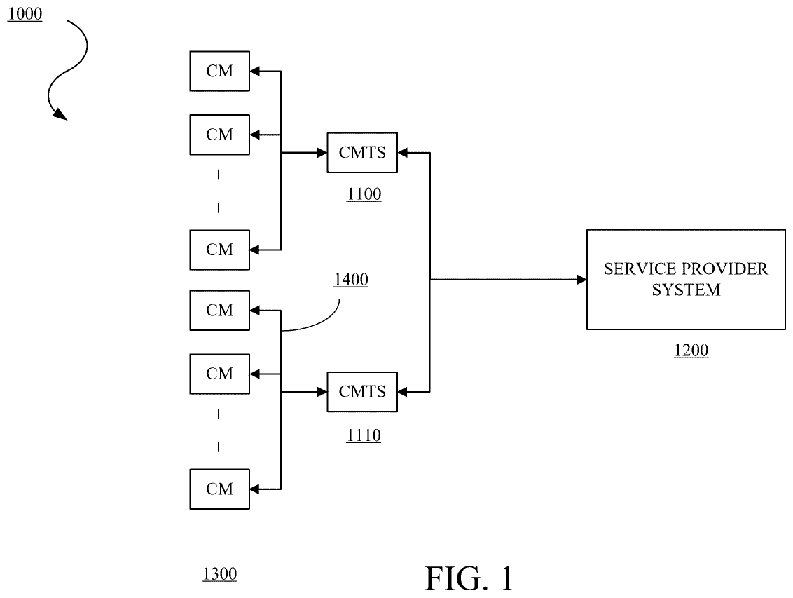

FIG. 1 is a diagram of an example of a system architecture 1000 in accordance with embodiments of this disclosure. In implementations, the system architecture 1000 can include a cable modem termination system (CMTS) 1100 and 1110 via which a service provider system 1200 can provide cable, television, Internet, voice, and like services to premises, residences, offices, and the like (collectively “premises”) via one or more cable modems 1300. The CMTS 1100 and 1110 are connected to or in communication with (collectively “connected to”) the cable modems 1300 via a hybrid fiber coaxial (HFC) network 1400. In implementations, the description herein is also applicable to systems based on distributed access architecture (DAA) where certain functionality in a service provider headend or hub is closer to a subscriber or customer. The connections and/or communications between elements or components in the system architecture 1000 can include wired communications, wireless communications, or a combination thereof, as appropriate. The system architecture 1000 and each element or component in the system architecture 1000 is illustrative and can include additional, fewer or different devices, entities, element, components, and the like which can be similarly or differently architected without departing from the scope of the specification and claims herein. Moreover, the illustrated devices, entities, element, and components can perform other functions without departing from the scope of the specification and claims herein.

As described herein, the CMTS 1100 and 1110 can provide cable, television, Internet, voice, and like services to premises. The CMTS 1100 and 1110 can receive a defined set of PMA profiles from the service provider system 1200 and provide the PMA profiles for selection by the cable modems 1300, as appropriate.

The cable modems 1300 convert data for transmission over a transmission medium such as the HFC network 1400 and the like. The cable modems 1300 encode and decode digital information for transmission and reception. The cable modems can send, via the CMTS 1100 and 1110 as appropriate, telemetry data such as but not limited to, signal-to-noise measurements, receive modulation error ratio (RxMER), and/or other signal quality data. The RxMER is per subcarrier in the OFDM channel. That is, the RxMER per subcarrier provides an MER measurement for each subcarrier in the OFDM channel (i.e., downstream). The cable modems 1300 can select a PMA profile from the defined set of PMA profiles from an associated CMTS 1100 and 1110 that optimizes performance, provides widest or highest bandwidth, and/or other channel metric. The cable modem 1300 is an example of customer premises equipment (CPE) and other CPE devices which include the functionality of the cable modem 1300 can be used without departing from the scope of the specification or claims.

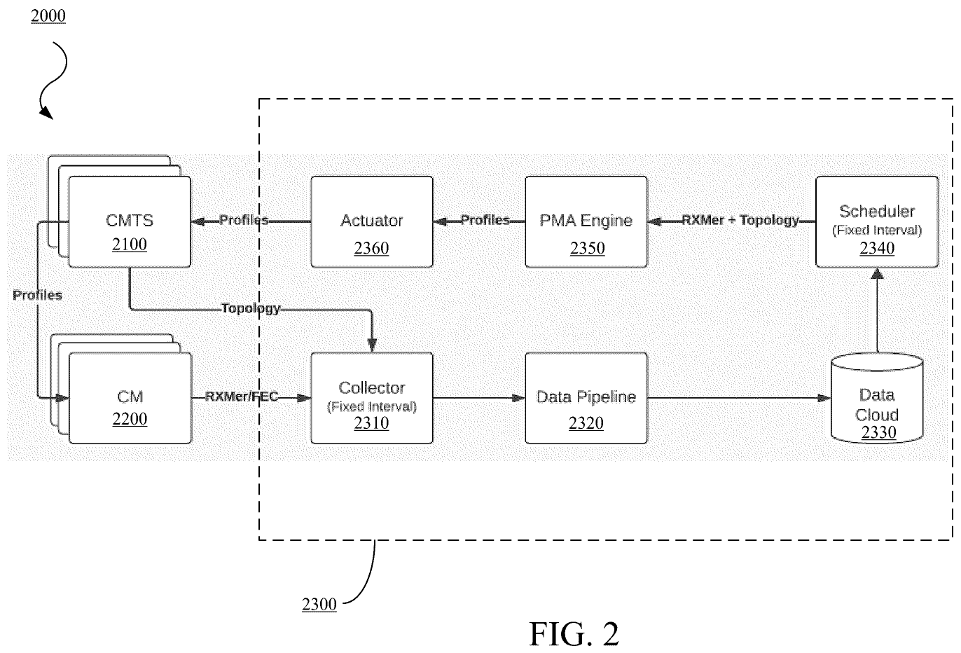

FIG. 2 is a diagram of an example of profile management application (PMA) processing 2000 on a fixed interval as is conventionally done absent the teachings described herein. The PMA processing 2000 can be performed in a system, such as the system architecture 1000 of FIG. 1, collectively by a CMTS(s) 2100, a cable modem(s) 2200, and a service provider system 2300. The service provider system 2300 can include, but is not limited to, a collector 2310, a data pipeline engine 2320, a data cloud 2330, a scheduler 2340, a PMA engine 2350, and an actuator 2360. The CMTS(s) 2100, CM(s) 2200, the service provider system 2300, and the components in the service provider system 2300 are connected. The connections and/or communications can include wired communications, wireless communications, or a combination thereof, as appropriate. Each element or component is illustrative and can include additional, fewer or different devices, entities, element, components, and the like which can be similarly or differently architected without departing from the scope of the specification and claims herein. Moreover, the illustrated devices, entities, element, and components can perform other functions without departing from the scope of the specification and claims herein.

The collector 2310 can collect telemetry data from each CM 2200. In implementations, the collector 2310 can obtain CM topology information from the CMTS(s) 2100. The collector 2310 operates on a fixed interval for collecting the telemetry data.

The data pipeline engine 2320 can process the collected telemetry data by application of data transformation and manipulation techniques.

The data cloud 2330 can store the processed telemetry data. In implementations, the data cloud 2330 can be any data management architecture and/or integrated data management system that can include data stores, memory, and supporting data infrastructure. In implementations, the processed telemetry data can be stored in memory.

The scheduler 2340 can control how often the PMA processing 2000 is executed and applied to the CMTS(s) 2100. The scheduler 2340 operates on a fixed interval for application of the PMA profiles to the CM(s) 2200 via the CMTS(s) 2100.

The PMA engine 2350 can analyze the telemetry data, such as the RxMER data, and the topology data to determine a defined set of PMA profiles as described, for example, in U.S. Pat. No. 11,546,080, issued Jan. 3, 2023, and entitled “SYSTEMS AND METHODS FOR DOCSIS PROFILE MANAGEMENT”, the contents of which are incorporated herein by reference in its entirety as if set forth herein. The PMA engine 2350 can review the telemetry data and determine the defined set of PMA profiles on a per OFDM channel or service group basis. The PMA engine 2350 can cluster the telemetry data into bad areas and good areas to determine the defined set of PMA profiles that optimizes the OFDM channel, i.e., where the defined set of PMA profiles attempts to optimize the performance for as many of the CM(s) 2200 as possible relative to a OFDM channel or service group.

The actuator 2360 can apply data transformation and manipulation techniques to match each defined set of PMA profiles to applicable CM vendor templates. The actuator 2360 can apply the matched defined set of PMA profiles to appropriate CMTS(s) 2100.

The CMTS(s) 2100 and the CM(s) can process and/or use the defined set of PMA profiles perform as described herein with respect to FIG. 1.

Operationally, the collector 2310 can obtain telemetry data from the CM(s) 2200 and topology data from the CMTS(s) 2100 at a fixed interval. The telemetry data is processed via the data pipeline 2320 and stored in the data cloud 2330. The scheduler 2340 can schedule processing by the PMA engine 2350 at a fixed interval. The PMA engine 2350 can determine or equate a defined set of PMA profiles as scheduled by the scheduler 2340. The actuator 2360 can process the determined defined set of PMA profiles and send the processed defined set of PMA profiles to appropriate CMTS(s) 2100. The CM(s) 2200 can select and apply a PMA profile from the defined set of PMA profiles at the appropriate CMTS 2100. In this instance, the PMA processing 2000 including the collection of the telemetry data, the determination of the PMA profiles, and the application of the PMA profiles at the CM(s) 2200 via the CMTS(s) 2100 are done at a fixed interval basis. As noted, the application of PMA processing across the entire service provider network at short, fixed time intervals is costly and resource intensive. Network efficiency, customer experience, and resource utilization are not optimized.

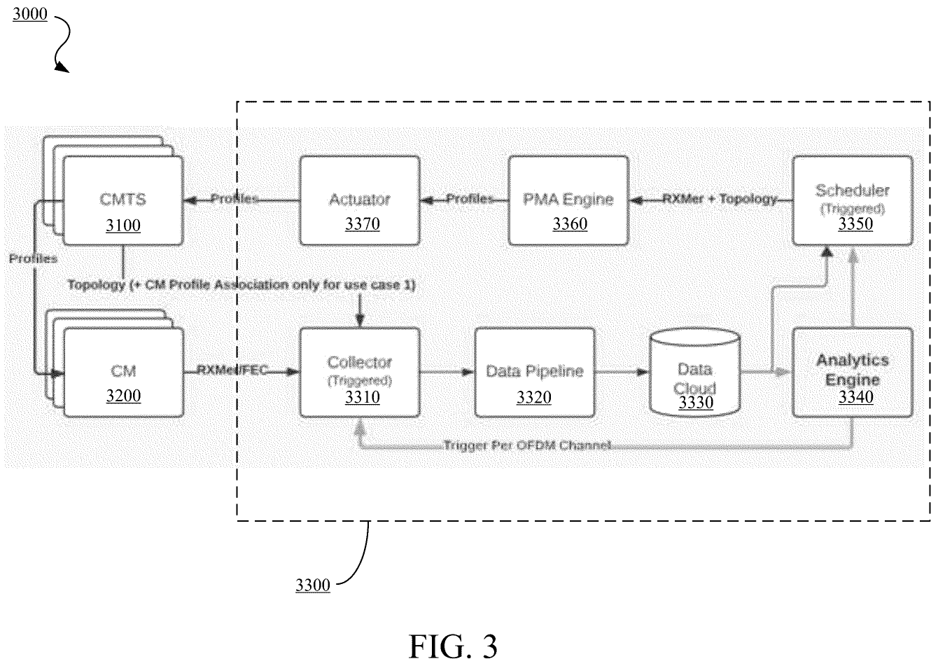

FIG. 3 is a diagram of an example of dynamic PMA processing 3000 in accordance with embodiments of this disclosure. The PMA processing 3000 can be performed in a system, such as the system architecture 1000 of FIG. 1, collectively by a CMTS(s) 3100, CM(s) 3200, and a service provider system 3300. The service provider system 3300 can include, but is not limited to, a collector 3310, a data pipeline engine 3320, a data cloud 3330, an analytics engine 3340, a scheduler 3350, a PMA engine 3360, and an actuator 3370. The CMTS(s) 3100, CM(s) 3200, the service provider system 3300, and the components in the service provider system 3300 are connected. The connections and/or communications can include wired communications, wireless communications, or a combination thereof, as appropriate. Each element or component is illustrative and can include additional, fewer or different devices, entities, element, components, and the like which can be similarly or differently architected without departing from the scope of the specification and claims herein. Moreover, the illustrated devices, entities, element, and components can perform other functions without departing from the scope of the specification and claims herein.

The CMTS(s) 3100, the CM(s) 3200, the collector 3310, the data pipeline engine 3320, the data cloud 3330, the scheduler 3350, the PMA engine 3360, and the actuator 3370 can operate and function as described herein with respect to FIG. 1 and FIG. 2 except as selectively triggered or controlled by the analytics engine 3340 as described herein.

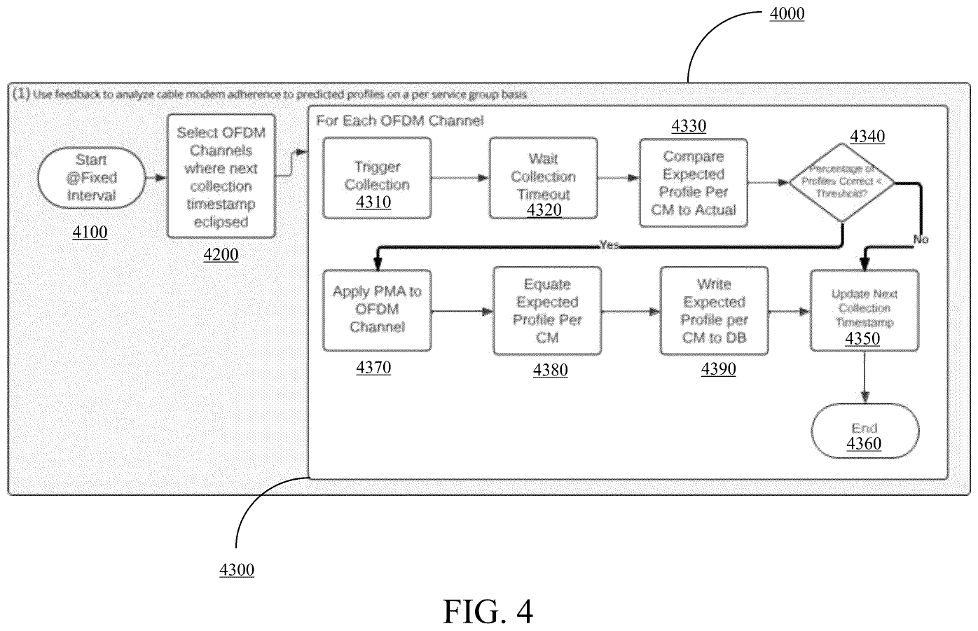

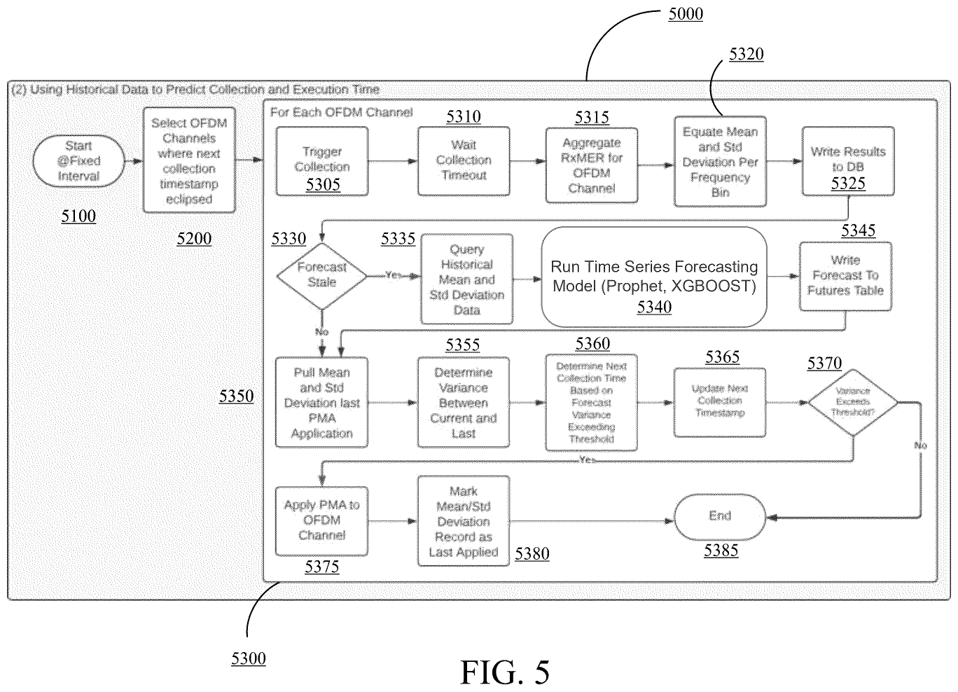

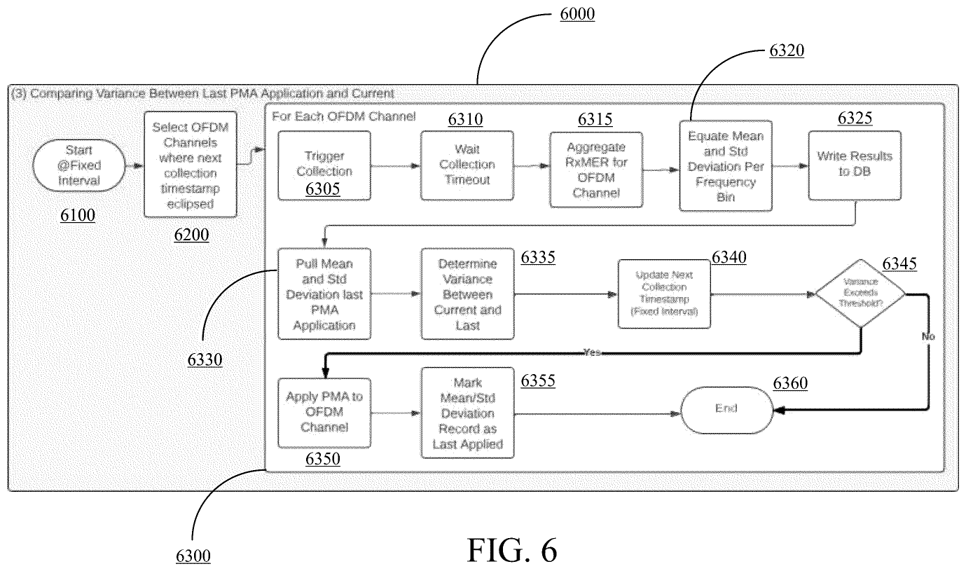

The analytics engine 3340 can dynamically control or select optimal times to complete one or more processing portions of the dynamic PMA processing 3000 based on an analysis of one or more of telemetry data, topology data, CM profile association data, and/or combinations thereof. In implementations, the analytics engine 3340 can dynamically control or select optimal times to collect telemetry from the CM(s) 3200, equate or determine new PMA profiles, and apply the new PMA profiles. The analytics engine 3340 can use a variety and/or a combination of techniques to collect telemetry data, equate PMA profiles, and apply PMA profiles. In implementations, the analytics engine 3340 can use feedback to analyze cable modem adherence to predicted profiles on a per OFDM channel or service group basis as described with respect to FIG. 4. In implementations, the analytics engine 3340 can use historical data to predict optimal time based on anticipated signal variance on a per OFDM channel or service group basis as described with respect to FIG. 5. In implementations, the analytics engine 3340 can compare the last collected telemetry data to the telemetry data used to equate a current PMA profile to determine if a telemetry data variance exceeds a telemetry data threshold required to trigger PMA application on a per OFDM channel or service group basis as described with respect to FIG. 6.

Operationally, each CM(s) 3200 is operating with or using a PMA profile selected by each CM(s) 3200 from a defined set of PMA profiles offered by the service provider system 3300 via an associated CMTS from the CMTS(s) 3100. In accordance with the one or more dynamic methods and/or techniques employed by the analytics engine 3340, the analytics engine 3340 can analyze one or more of telemetry data, topology data, CM profile association data, and/or combinations thereof to dynamically set trigger times (e.g., timestamps) for at least one of collection of telemetry data, determination or equating of PMA profiles, and application of PMA profiles. In effect, the setting of the trigger times control the collector 3310, the scheduler 3350, and/or combinations thereof. In implementations, the analytics engine 3340 can use a combination of fixed interval timing and dynamic triggered timing to dynamically control the dynamic PMA processing 3000. In implementations, the combination of fixed interval timing and dynamic triggered timing can include at least one dynamic triggered timing process portion. In implementations, the combination of fixed interval timing and dynamic triggered timing can include dynamic triggered timing for all process portions. In implementations, the analytics engine 3340 can use dynamic triggered timing absent fixed interval timing to dynamically control the dynamic PMA processing 3000.

In implementations, the analytics engine 3340 can set and/or update timestamps to collect telemetry data, topology data, and/or other data, or trigger the collector 3310 to collect the telemetry data, topology data, and/or other data. In implementations, the analytics engine 3340 can use fixed interval timing. In implementations, the analytics engine 3340 can use dynamic triggered timing based on the telemetry data, topology data, and/or other data.

In implementations, the analytics engine 3340 can apply statistical and/or comparative analysis with respect to the telemetry data, topology data, and/or other data to determine whether the PMA engine should determine or equate a defined set of PMA profiles, apply a defined set of PMA profiles, and/or combinations thereof.

In this instance, the dynamic PMA processing 3000 including the collection of the telemetry data, the determination of the PMA profiles, and the application of the PMA profiles at the CM(s) 3200 via the CMTS(s) 3100 are done using dynamic triggered timing for at least one of the process portions (e.g., data collection, PMA profile determination, and/or PMA profile application). The use of dynamic triggered timing on at least one of process portions can increase or optimize network efficiency, customer experience, and resource utilization.

FIG. 4 is a diagram of an example of the dynamic PMA processing 3000 of FIG. 3 using a PMA profile feedback method 4000 in accordance with embodiments of this disclosure. That is, the PMA profile feedback method 4000 can use feedback from CM(s) to analyze adherence to a predicted profile on a per service group or OFDM channel basis. The PMA profile feedback method 4000 can be performed by the service provider system 1200 and/or 3300 and collectively performed by the analytics engine 3340, the collector 3310, the scheduler 3350, the PMA engine 3360, and the actuator 3370.

At 4100, at a fixed interval, the analytics engine 3340 can review collection timestamps stored in a database, data cloud, and/or memory. At 4200, the analytics engine 3340 can select OFDM channels for which a collection timestamp has expired. In implementations, the analytics engine 3340 can receive alerts for expired collection timestamps.

At 4300, for each OFDM channel or service group, the analytics engine 3340 can execute a feedback analysis. At 4310, the analytics engine 3340 can trigger the collector 3310 to collect data from associated CM(s) 3200 and CMTS 3100. In this instance, the data can include telemetry data, CM PMA profile association data (actual PMA profile being used by CM), topology data, and/or other data. At 4320, a defined wait period is executed to enable the data pipeline 3320 to process the data and store the processed data in the data cloud 3330. The defined wait period is an illustrative method but other techniques can be used. In implementations, a trigger for further processing can be receipt of the data in the data cloud 3330.

At 4330, for each associated CM in the OFDM channel, the analytics engine 3340 can compare the actual PMA profile being used by a CM (from the CM PMA profile association data) against an expected PMA profile stored in a database or the data cloud 3330. In implementations, a counter or a count of the number of CMs using the expected PMA profile is maintained (collectively “matched counter”). At 4340, the analytics engine 3340 can determine whether a percentage of the CMs (based on a value in the matched counter) is less than a defined threshold (i.e., a matched threshold).

If the value of the percentage equals or exceeds the defined threshold, at 4350, the analytics engine 3340 can update a collection timestamp for the analyzed OFDM channels, and the process ends at 4360. That is, the number of CMs using the expected PMA profile exceeds the defined threshold. In implementations, the collection timestamp can be updated using a fixed interval. In implementations, the collection timestamp can be updated using a dynamic triggered timing based on, for example, a value of the percentage. In implementations, a long or short time interval can be used based on how close the value of the percentage is to the matched threshold.

At 4350, if the value of the percentage is less than the defined threshold, at 4370, the analytics engine 3340 can dynamically trigger the scheduler 3350 to initiate the PMA engine 3360 to determine or equate PMA profiles based on the telemetry data and the topology data. The actuator 3370 can process the determined PMA profiles for application to the applicable CMTS(s) 3100 and CM(s) 3200.

At 4380, the analytics engine 3340 can determine an expected PMA profile for each of the CM(s) 3200 and at 4390, store the expected PMA profile in the data cloud 3330. At 4350, the analytics engine 3340 can update a collection timestamp for the analyzed OFDM channels, and the process ends at 4360. In implementations, the collection timestamp can be updated using a fixed interval. In implementations, the collection timestamp can be updated using a dynamic triggered timing based on, for example, a value of the percentage. In implementations, a long or short time interval can be used based on how close the value of the percentage is to the matched threshold.

FIG. 5 is a diagram of an example of the dynamic PMA processing 3000 of FIG. 3 using a historical data method 5000 in accordance with embodiments of this disclosure. That is, the historical data method 5000 can use historical data to dynamically predict and set collection times, and trigger execution of PMA profile determination and application, both on a per service group or OFDM channel basis. The historical data method 5000 can be performed by the service provider system 1200 and/or 3300 and collectively performed by the analytics engine 3340, the collector 3310, the scheduler 3350, the PMA engine 3360, and the actuator 3370.

At 5100, at a fixed interval, the analytics engine 3340 can review collection timestamps stored in a database, data cloud, and/or memory. At 5200, the analytics engine 3340 can select OFDM channels for which a collection timestamp has expired. In implementations, the analytics engine 3340 can receive alerts for expired collection timestamps.

At 5300, for each OFDM channel or service group, the analytics engine 3340 can execute a historical data analysis. At 5305, the analytics engine 3340 can trigger the collector 3310 to collect data from associated CM(s) 3200 and CMTS 3100. In this instance, the data can include telemetry data, topology data, and/or other data. At 5310, a defined wait period is executed to enable the data pipeline 3320 to process the data and store the processed data in the data cloud 3330.

At 5315, the analytics engine 3340 can aggregate the signal quality data of the telemetry data, such as the RxMER data, for the OFDM channel from all the CM(s) 3200. The analytics engine 3340 can divide the OFDM channel into a defined number of frequency bins based on the bandwidth of the OFDM channel and a bandwidth of a subcarrier in the OFDM channel (e.g., number of frequency bins=OFDM channel bandwidth/subcarrier bandwidth). In implementations, the OFDM channel can have a bandwidth of 192 MHz and a subcarrier in the OFDM channel can have a bandwidth of 50 KHz. Therefore, there would be 3,840 frequency bins. At 5320, the analytics engine 3340 can determine statistical metrics for the RxMER data on a per subcarrier basis. In implementations, the analytics engine 3340 can determine mean and standard deviation for each frequency bin. At 5325, the analytics engine 3340 can store the statistical metrics in the data cloud 3330.

At 5330, the analytics engine 3340 can determine if a previous statistical metrics forecast model is stale. Stale analysis can be performed using machine learning techniques based on defined periods of time with respect to the forecast, variance, and defined variance thresholds. If the previous statistical metrics forecast model is stale, at 5335, the analytics engine 3340 can query, for example the data cloud 3330, for historical statistical metrics data. At 5340, the analytics engine 3340 can run or execute time series forecasting on the queried historical statistical metrics data to generate a current time series forecasting model. In implementations, temperature data, environment data, and other data can be used to further refine the time series forecasting model. At 5345, the analytics engine 3340 can store the current time series forecasting model in the data cloud 3330.

At 5350, if the previous statistical metrics forecast model is stale or after storing of the current time series forecasting model, the analytics engine 3340 can retrieve the statistical metrics data associated with the last determined set of PMA profiles. At 5355, the analytics engine 3340 can determine a variance between the retrieved statistical metrics data and the current statistical metrics data. At 5360, the analytics engine 3340 can determine a collection time based on the variance and because the forecast model is stale. In implementations, a sliding scale can be is used where longer collection times can be used if the variance is well below a variance threshold and shorter times are used if the variance is closer and/or exceeding the variance threshold (i.e., when a channel is well-behaved and measurements stay consistent). At 5365, the analytics engine 3340 can update the collection timestamp in view of the determined collection time.

At 5370, if the variance (determined at 5355) exceeds the variance threshold, then at 5375, the analytics engine 3340 can dynamically trigger the scheduler 3350 to initiate the PMA engine 3360 to determine or equate PMA profiles based on the telemetry data and the topology data. The variance can exceed the variance threshold when the statistical metrics for telemetry data is indicating a significant change in signal conditions for the channel. That is, there has been a significant shift in either average or mean telemetry data or the standard deviation has changed significantly indicating that similar average telemetry data may exist but the number of outliers has increased significantly (noting that these measurements are looking across a set of 100s of cable modem telemetry data). Both the standard deviation and averages are needed because some cable modems can have a low signal quality telemetry data and others can have high signal quality telemetry data that can average out the numbers. The actuator 3370 can process the determined PMA profiles for application to the applicable CMTS(s) 3100 and CM(s) 3200. At 5380, the current statistical metrics data can be stored as the last applied statistical metrics data. At 5380, if the variance does not exceed the variance threshold and the last applied statistical metrics data is stored, the process ends.

FIG. 6 is a diagram of an example of the dynamic PMA processing 3000 using a telemetry data comparison method 6000 in accordance with embodiments of this disclosure. That is, the telemetry data comparison method 6000 can compare statistical metrics from current telemetry data with stored statistical metrics for a last determined set of PMA profiles to dynamically predict and set collection times, and trigger execution of PMA profile determination and application, both on a per service group or OFDM channel basis. The telemetry data comparison method 6000 can be performed by the service provider system 1200 and/or 3300 and collectively performed by the analytics engine 3340, the collector 3310, the scheduler 3350, the PMA engine 3360, and the actuator 3370.

At 6100, at a fixed interval, the analytics engine 3340 can review collection timestamps stored in a database, data cloud, and/or memory. At 6200, the analytics engine 3340 can select OFDM channels for which a collection timestamp has expired. In implementations, the analytics engine 3340 can receive alerts for expired collection timestamps.

At 6300, for each OFDM channel or service group, the analytics engine 3340 can execute a telemetry data comparison analysis. At 6305, the analytics engine 3340 can trigger the collector 3310 to collect data from associated CM(s) 3200 and CMTS 3100. In this instance, the data can include telemetry data, topology data, and/or other data. At 6310, a defined wait period is executed to enable the data pipeline 3320 to process the data and store the processed data in the data cloud 3330.

At 6315, the analytics engine 3340 can aggregate the signal quality data of the telemetry data, such as the RxMER data, for the OFDM channel from all the CM(s) 3200. The analytics engine 3340 can divide the OFDM channel into a defined number of frequency bins based on the bandwidth of the OFDM channel and a bandwidth of a subcarrier in the OFDM channel (e.g., number of frequency bins=OFDM channel bandwidth/subcarrier bandwidth). In implementations, the OFDM channel can have a bandwidth of 192 MHz and a subcarrier in the OFDM channel can have a bandwidth of 50 KHz. Therefore, there would be 3,840 frequency bins. At 6320, the analytics engine 3340 can determine statistical metrics for the RxMER data on a per subcarrier basis. In implementations, the analytics engine 3340 can determine mean and standard deviation for each frequency bin. At 6325, the analytics engine 3340 can store the statistical metrics in the data cloud 3330.

At 6330, the analytics engine 3340 can retrieve the statistical metrics data associated with the last determined set of PMA profiles. At 6335, the analytics engine 3340 can determine a variance between the retrieved statistical metrics data and the current statistical metrics data. At 6340, the analytics engine 3340 can update the collection timestamp based on a fixed interval.

At 6345, if the variance exceeds the variance threshold, then at 6350, the analytics engine 3340 can dynamically trigger the scheduler 3350 to initiate the PMA engine 3360 to determine or equate PMA profiles based on the telemetry data and the topology data. The actuator 3370 can process the determined PMA profiles for application to the applicable CMTS(s) 3100 and CM(s) 3200. At 6355, the current statistical metrics data can be stored as the last applied statistical metrics data. At 6360, if the variance does not exceed the variance threshold and the last applied statistical metrics data is stored, the process ends.

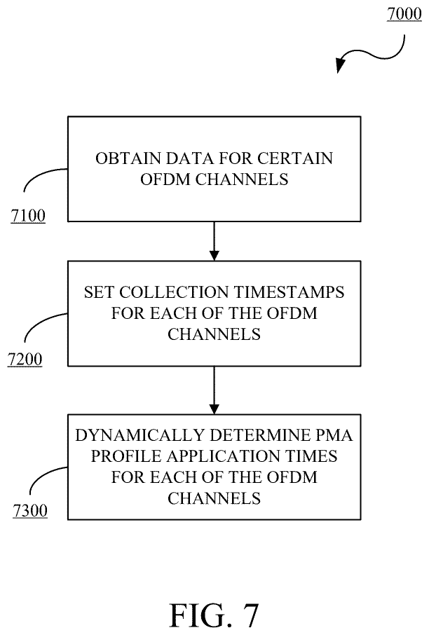

FIG. 7 is a flowchart of an example method 7000 for automated optimization of PMA processing for downstream channels in a service provider network in accordance with embodiments of this disclosure. The method 7000 includes: obtaining 7100 data for certain downstream or OFDM channels; setting or updating 7200 collection timestamps for each of the OFDM channels; and dynamcially determining 7300 PMA profile application times for each of the OFDM channels. The method 7000 can be implemented, for example, in or by components described with respect to FIGS. 1-6, and 8, as appropriate and applicable based on the description herein, and in conjunction with any of the flows described with respect to FIGS. 1-6, as appropriate and applicable based on the description herein.

The method 7000 includes obtaining 7100 data for certain OFDM channels. The service provider system and components therein can retrieve telemetry data, topological data, actual PMA profile data, and/or other data for each OFDM channel where a collection timestamp and/or timer has expired. The data can include, but is not limited to, telemetry data, topological data, actual PMA profile data, and/or other data that can be collected from CM(s) and CMTS(s) associated with each of the OFDM channels.

The method 7000 includes setting or updating 7200 collection timestamps for each of the OFDM channels. Once processed as described herein, the service provider system and components therein can set future collection timestamps and/or set timers, accordingly.

The method 7000 includes dynamically determining 7300 PMA profile application times for each of the OFDM channels. Once a collection timestamp and/or timer has expired, the service provider system and components therein can process the telemetry data, topological data, actual PMA profile data, and/or other data, as appropriate, to determine PMA profile processing. In implementations, the service provider system and components therein can use dynamic triggered timing basis to set or update collection timestamps, determine PMA profile application times, and/or combinations thereof. In implementations, the service provider system and components therein can set or update collection timestamps and/or timers using fixed interval timing and determine PMA profile application times using dynamic triggered timing basis. In implementations, the service provider system and components therein can set or update collection timestamps and/or timers using a dynamic timing basis and determine the PMA profile application times using a dynamic timing basis, both based on using all or some portions of the collected telemetry data, topological data, actual PMA profile data, and/or other data.

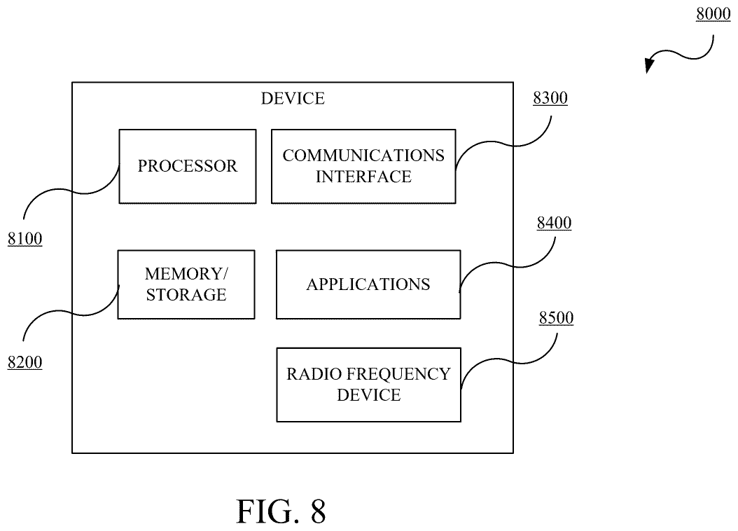

FIG. 8 is a block diagram of an example of a device 8000 in accordance with embodiments of this disclosure. The device 8000 may include, but is not limited to, a processor 8100, a memory/storage 8200, a communication interface 8300, applications 8400, and, if needed, a radio frequency device 8500. The device 8000 may include or implement, for example, the components described with respect to FIGS. 1-7. The applicable or appropriate flows, techniques, or methods described herein may be stored in the memory/storage 8200 and executed by the processor 8100 in cooperation with the memory/storage 8200, the communications interface 8300, the applications 8400, and the radio frequency device 8500 (when applicable), as appropriate. The device 8000 may include other elements which may be desirable or necessary to implement the devices, systems, and methods described herein. However, because such elements and steps do not facilitate a better understanding of the disclosed embodiments, a discussion of such elements and steps may not be provided herein.

Described herein is a method for optimizing profile management application processing for downstream channels in a service provider network. In implementations, a method for automated optimization of profile management application (PMA) processing for downstream channels in a service provider network includes obtaining, by a collector in a service provider system from cable modems in a service provider network, data for downstream channels having expired collection timestamps, setting, by an analytics engine, the collection timestamps for each of the downstream channels, and dynamically determining, by the analytics engine, PMA profile application times for each of the downstream channels based on at least the data.

In implementations, the setting of the collection timestamps is done on a fixed interval basis. In implementations, the setting of the collection timestamps is done on a dynamic timing basis based on at least the data. In implementations, the method further includes obtaining, by the collector in the service provider system from cable modem termination system in the service provider network, topology data for downstream channels having expired collection timestamps. In implementations, the data is telemetry data and wherein the dynamically determining the PMA profile application times for each of the downstream channels is based on at least the telemetry data and the topology data. In implementations, the data is telemetry data and where the setting of the collection timestamps is done on a dynamic timing basis based on at least the telemetry data and the topology data. In implementations, the data is actual PMA profile data used by the cable modems. In implementations, the dynamically determining further includes comparing, by the analytics engine, the actual PMA profile data used by each cable modems against an expected PMA profile, and triggering, by the analytics engine, a PMA profile application process when a percentage of the cable modems using the expected PMA profile is below a defined threshold. In implementations, the data is telemetry data. In implementations, the dynamically determining further includes aggregating, by the analytics engine, the telemetry data for each downstream channel, determining, by the analytics engine, statistical metrics data for the aggregated telemetry data for each downstream channel, determining, by the analytics engine, variance between the statistical metrics data for the aggregated telemetry data and a statistical metrics data for last generated PMA profiles, and triggering, by the analytics engine, a PMA profile application process when the variance exceeds a defined threshold. In implementations, the setting further includes determining, by the analytics engine, staleness of a previous forecasting model which is based on historical statistical metrics data, and setting the collection timestamps using variances determined from forecasted statistical metrics data from the previous forecasting model and the statistical metrics data for the aggregated telemetry data when the previous forecasting model is not stale. In implementations, the setting further includes determining, by the analytics engine, a current forecasting model based on historical statistical metrics data when the previous forecasting model is stale, and setting the collection timestamps using variances determined from forecasted statistical metrics data from the current forecasting model and the statistical metrics data for the aggregated telemetry data.

Described herein is a system and method for optimizing profile management application processing for downstream channels in a service provider network. In implementations, a service provider system includes a collector configured to obtain data from premises devices in a service provider network for downstream channels having expired timers; and an analytics engine. The analytics engine configured to set the timers for each of the downstream channels, and dynamically determine profile management application (PMA) profile application times for each of the downstream channels based on at least the data.

In implementations, the setting of the timers is done on a fixed interval basis. In implementations, the setting of the timers is done on a dynamic timing basis based on at least the data. In implementations, the analytics engine is further configured to obtain topology data from cable modem termination system in the service provider network, and dynamically determine the profile management application (PMA) profile application times for each of the downstream channels based on at least the data and the topology data. In implementations, the data is one of actual PMA profiles used by the premises devices and telemetry data. In implementations, the analytics engine is further configured to initiate a PMA profile application process when a percentage of the premises devices using an expected PMA profile versus an actual PMA profile is below a defined threshold. In implementations, the analytics engine is further configured to aggregate the telemetry data for each downstream channel, determine statistical metrics data for the aggregated telemetry data for each downstream channel, determine a variance between the statistical metrics data for the aggregated telemetry data and a statistical metrics data for last generated PMA profiles, and initiate a PMA profile application process when the variance exceeds a defined threshold. In implementations, the analytics engine is further configured to determine staleness of a previous forecasting model which is based on historical statistical metrics data, and set the timers using variances determined from forecasted statistical metrics data from the previous forecasting model and the statistical metrics data for the aggregated telemetry data when the previous forecasting model is not stale, determine a current forecasting model based on historical statistical metrics data when the previous forecasting model is stale, and set the timers using variances determined from forecasted statistical metrics data from the current forecasting model and the statistical metrics data for the aggregated telemetry data.

Although some embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for automated optimization of profile management application (PMA) processing for downstream channels in a service provider network, the method comprising:
obtaining, by a collector in a service provider system from cable modems in a service provider network, data for downstream channels having expired collection timestamps;
setting, by an analytics engine, the collection timestamps for each of the downstream channels; and
dynamically determining, by the analytics engine, PMA profile application times for each of the downstream channels based on at least the data.

2. The method of claim 1, wherein the setting of the collection timestamps is done on a fixed interval basis.

3. The method of claim 1, wherein the setting of the collection timestamps is done on a dynamic timing basis based on at least the data.

4. The method of claim 1, further comprising:
obtaining, by the collector in the service provider system from cable modem termination system in the service provider network, topology data for downstream channels having expired collection timestamps.

5. The method of claim 4, wherein the data is telemetry data and wherein the dynamically determining the PMA profile application times for each of the downstream channels is based on at least the telemetry data and the topology data.

6. The method of claim 4, wherein the data is telemetry data and where the setting of the collection timestamps is done on a dynamic timing basis based on at least the telemetry data and the topology data.

7. The method of claim 1, wherein the data is actual PMA profile data used by the cable modems.

8. The method of claim 7, wherein the dynamically determining further comprising:
comparing, by the analytics engine, the actual PMA profile data used by each cable modems against an expected PMA profile; and
triggering, by the analytics engine, a PMA profile application process when a percentage of the cable modems using the expected PMA profile is below a defined threshold.

9. The method of claim 1, wherein the data is telemetry data.

10. The method of claim 9, wherein the dynamically determining further comprising:
aggregating, by the analytics engine, the telemetry data for each downstream channel;
determining, by the analytics engine, statistical metrics data for the aggregated telemetry data for each downstream channel;
determining, by the analytics engine, variance between the statistical metrics data for the aggregated telemetry data and a statistical metrics data for last generated PMA profiles; and
triggering, by the analytics engine, a PMA profile application process when the variance exceeds a defined threshold.

11. The method of claim 10, wherein the setting further comprising:
determining, by the analytics engine, staleness of a previous forecasting model which is based on historical statistical metrics data; and
setting the collection timestamps using variances determined from forecasted statistical metrics data from the previous forecasting model and the statistical metrics data for the aggregated telemetry data when the previous forecasting model is not stale.

12. The method of claim 11, wherein the setting further comprising:
determining, by the analytics engine, a current forecasting model based on historical statistical metrics data when the previous forecasting model is stale; and
setting the collection timestamps using variances determined from forecasted statistical metrics data from the current forecasting model and the statistical metrics data for the aggregated telemetry data.

13. A service provider system, comprising:
a collector configured to obtain data from premises devices in a service provider network for downstream channels having expired timers; and
an analytics engine configured to:
set the timers for each of the downstream channels; and
dynamically determine profile management application (PMA) profile application times for each of the downstream channels based on at least the data.

14. The service provider system of claim 13, wherein the setting of the timers is done on a fixed interval basis.

15. The service provider system of claim 13, wherein the setting of the timers is done on a dynamic timing basis based on at least the data.

16. The service provider system of claim 13, wherein the analytics engine is further configured to:
obtain topology data from cable modem termination system in the service provider network; and
dynamically determine the profile management application (PMA) profile application times for each of the downstream channels based on at least the data and the topology data.

17. The service provider system of claim 13, wherein the data is one of actual PMA profiles used by the premises devices and telemetry data.

18. The service provider system of claim 17, wherein the analytics engine is further configured to:
initiate a PMA profile application process when a percentage of the premises devices using an expected PMA profile versus an actual PMA profile is below a defined threshold.

19. The service provider system of claim 17, wherein the analytics engine is further configured to:
aggregate the telemetry data for each downstream channel;
determine statistical metrics data for the aggregated telemetry data for each downstream channel;
determine a variance between the statistical metrics data for the aggregated telemetry data and a statistical metrics data for last generated PMA profiles; and
initiate a PMA profile application process when the variance exceeds a defined threshold.

20. The service provider system of claim 19, wherein the analytics engine is further configured to:
determine staleness of a previous forecasting model which is based on historical statistical metrics data;
set the timers using variances determined from forecasted statistical metrics data from the previous forecasting model and the statistical metrics data for the aggregated telemetry data when the previous forecasting model is not stale;
determine a current forecasting model based on historical statistical metrics data when the previous forecasting model is stale; and
set the timers using variances determined from forecasted statistical metrics data from the current forecasting model and the statistical metrics data for the aggregated telemetry data.
